(19) United States
(12) Patent Application Publication
(10) Pub. No.: US 2018/0165599 A1
(43) Pub. Date: Jun. 14, 2018

(54) PREDICTIVE MODEL INTEGRATION

(71) Applicant: BUSINESS OBJECTS SOFTWARE LTD., Dublin (IE)

(72) Inventors: Balazs Pete, Dublin (IE); Declan Kearney, Dublin (IE); Cathal McGovern, Dublin (IE); Simon Dornan, Dublin (IE); Jennifer Keane, Dublin (IE); Michael Golden, Dublin (IE); Orla Cullen, Castleknock (IE); Robert McGrath, Dublin (IE); Shekhar Chhabra, Dublin (IE); Kerry O'Connor, Dublin (IE); Malte Christian Kaufmann, Dublin (IE); John Julian, Dublin (IE)

(21) Appl. No.: 15/376,271

(22) Filed: Dec. 12, 2016

(51) Int. Cl. G06N 99/00; G06F 17/50

(52) U.S. Cl. CPC G06N 99/005; G06F 17/5009

(57) ABSTRACT

Techniques are described for integrating predictive models into applications, to enable the applications to provide predictive functionality. Using the framework according to implementations, predictive models and their supporting libraries may be incorporated into applications without requiring application developers to be knowledgeable regarding the particular features of the predictive models and/or libraries. The framework exposes a common and consistent application programming interface (API) on top of the predictive libraries. Applications can use the API to interact with the predictive models, thus enabling the applications to leverage predictive functionality. Implementations also provide an API which may be used by applications to request the retraining of predictive models.

### BACKGROUND

Predictive models may be used to discover otherwise hidden insights, patterns, and/or relationships in various types of data. Based on the insights, patterns, and/or relationships, predictions may be made regarding future events. However, integrating predictive models into applications can be very complex, and may require developers to have specialized knowledge regarding the models. Integration may also consume a large amount of time and computing resources.

### SUMMARY

Implementations of the present disclosure are generally directed to employing predictive models to generate predictions. More particularly, implementations of the present disclosure are directed to a framework that enables applications to request that a predictive model be applied to generate predictions, and to request retraining of a predictive model.

In general, innovative aspects of the subject matter described in this specification can be embodied in methods that include actions of: providing a plurality of apply procedures that are each associated with a predictive model for generating predictions based on input data; receiving a first call from an application to an apply procedure and, in response, requesting that a predictive library execute a first version of the predictive model associated with the apply procedure; and providing, to the application, the predictions generated through execution of the first version of the predictive model.

These and other implementations can each optionally include one or more of the following innovative features: the actions further include receiving, from the application, a request to retrain the predictive model and, in response, sending an instruction to the predictive library to cause the predictive model to be retrained; the actions further include receiving an indication that the predictive model has been retrained to provide a second version of the predictive model; the actions further include receiving a second call from the application to the apply procedure and, in response, requesting that the predictive library execute the second version of the predictive model associated with the apply procedure; the actions further include providing, to the application, the predictions generated through execution of the second version of the predictive model; the first call and the second call from the application include the same set of input parameters; the plurality of apply procedures include one or more SQLScripts; the actions further include in response to receiving the first call from the application to the apply procedure, determining that the first version of the predictive model is the active version to be executed; the predictive library is at least one of a Predictive Analytics Library (PAL), an Automated Predictive Library (APL), or a R library; the first call includes one or more parameter values provided by the application; and/or the predictive model is executed based on the one or more parameter values.

Other implementations of any of the above aspects include corresponding systems, apparatus, and computer programs that are configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that aspects and features in accordance with the present disclosure can include any combination of the aspects and features described herein. That is, aspects and features in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present

[symbol]

### BRIEF DESCRIPTION OF DRAWINGS

FIG. 1 depicts an example system for predictive model integration, according to implementations of the present disclosure.

FIG. 2 depicts an example schematic of a model versioning hierarchy, according to implementations of the present disclosure.

FIG. 3 depicts a flow diagram of example processes for predictive model integration, according to implementations of the present disclosure.

FIG. 4 depicts an example system for predictive model integration, according to implementations of the present disclosure.

FIGS. 5A-5F depict example user interfaces, according to implementations of the present disclosure.

FIG. 6 depicts an example computing system, according to implementations of the present disclosure.

### DETAILED DESCRIPTION

Implementations of the present disclosure are directed to systems, devices, methods, and computer-readable media for integrating predictive models into applications, to enable the applications to provide predictive functionality. Using the framework described herein, predictive models and their supporting libraries may be incorporated into applications without requiring application developers to be knowledgeable regarding the particular features of the predictive models and/or libraries. Predictive models may include, but are not limited to, the Automated Predictive Library (APL) provided by SAP™, the HANA Predictive Analytics Library (PAL) provided by SAP™, the R library, and/or other suitable libraries and/or models.

The effort, time, and resources required to integrate a predictive model into an application may depend on the algorithm and the underlying technology. Traditionally the integration of a model into an application required considerable development work and often lengthy development cycles. Further, to ensure the accuracy of these models the models would traditionally need to be retrained or updated periodically, requiring further time, effort, and computing resources.

Implementations provide a framework that exposes a common and consistent application programming interface (API) on top of the predictive libraries. Applications can use the API to interact with the predictive models, thus enabling the applications to leverage predictive functionality with minimum expenditure of time, development effort, and/or computing resources. Implementations also provide an API which may be used by applications to request the retraining of predictive models.

As used herein, a predictive model is any appropriate model that includes one or more functions for analyzing data and generating a prediction based on the analysis. A predictive model may be trained, based on training data and using any suitable machine learning algorithms, to provide prediction results(s) based on input data. A predictive library is a set of tools that allow the creation of predictive models. Predictive models represent the information gathered by a library regarding the training dataset, e.g., all of the correlations and associations found in the data, that will be used in combination with additional tools available in the predictive library to generate predictions. Thus, a predictive model may be library dependent. A predictive model may be moved to a different installation of the library and employed generate predictions using learnings provided from a different system. Models may include any appropriate type of predictive model, such as models associated with APL, PAL, or R library, expert model(s), and so forth. In some instances, model(s) may be produced (e.g., trained) using a set of external tools or processes, and imported into a repository of the platform.

Traditionally, integrating predictive models into applications has also been challenging due to the requirement that developers manage the lifecycle of the predictive models. For example, developers may have a responsibility to keep track of and support newer models instead of older models when new models become available. Implementations provide a framework to ensure that the results of the predictive models can be consumed by the calling application. The framework also provides that the models are up to date and are performing optimally with respect to the data being analyzed. The framework also provides that a predictive model may be readily swapped out for a newer version of the model when a new version is available, without requiring substantial development effort.

Implementations provide a framework that is agnostic with respect to particular modelling engines. Through abstraction of the underlying predictive libraries, implementations allow applications to easily change the underlying predictive technology without changing the predictive integration approach and without affecting how the application consumes predictive capabilities. Implementations also provide a framework that includes a standardized and unified API through which applications can interact with predictive model(s) to retrieve metadata about the model(s), request the retraining of the model(s), and/or apply the model(s) to a dataset. In some implementations, the models may be called from applications using SQL statements, which abstract away the particular languages of the underlying libraries such as PAL, APL, R library, and so forth. Implementations also support the using of languages other than SQL to make calls from the applications.

In some implementations, the framework also provides for hot-swappable predictive models. For example, the framework and its API(s) provide the capability to change the predictive environment and algorithms on a system without any downtime (e.g., while application(s) are still executing) and without the need for additional development from the application development team.

In some implementations, models may be parameterized to enable an application to alter the behavior of a predictive model without requiring a new predictive model to be created. For example, an application may call an apply procedure (as described further below) to cause a predictive model to be executed. The call may include one or more parameter values that cause the predictive model to execute with different behavior, compared to its execution based on other parameter value(s). Accordingly, parametrization of the models may provide for greater flexibility in model behavior. In another example, when making a call to request retraining of a clustering model, the application may specify a parameter value to indicate how clusters are to be used during the training. As another example, when making a call to request execution of a time series model, the application may specify a parameter value to indicate how many data points are to be predicted in the future. Such parameters can change the behavior of the model, the results of the model, and/or the manner in which the model is to be retrained. A designer of a model could create a generic model and allow the model to be called according to different scenarios through use of different parameter values, instead of creating an individual predictive models for predicting five time points in the future, predicting six time points in the future, and so forth.

In some implementations, the framework also includes features that enable the retraining of predictive models being called by applications, without the need for application administrators to use an external tool to trigger such retraining. For example, an application may call a retrain procedure to request retraining of a particular model, such that the current active version of the model is replaced with an updated active version of the model.

In some implementations, the framework includes a modelling tool that allows data scientists or other users to publish predictive models, which may then be readily assigned to a predictive scenario (described further below) in a production system without the need for additional application development. Implementations may include a basic modelling tool that allows users to create a simple model based on a template and/or an out-of-the-box model. This allows application developers to provide an out-of-the-box model with a predictive scenario when they integrate the predictive analytics integrator (PAI) into their applications. In some instances, this out-of-the-box model may not be a real predictive model, but instead may be a template that allows PAI users to create a model version without having to use an advanced or external modelling tool. Implementations also allow for modeling tools to be connected to the PAI system. This allows data scientists to publish predictive models created in modeling tools, such as Predictive Analytics to be used in PAI without having to use additional tools to connect to the PAI system and import or register the predictive model. Modeling tools such as Predictive Analytics can read the PAI repository information (e.g., Predictive Scenarios, Model Versions, etc.) to determine what are the boundary conditions such as signatures and/or datasets, and allow data scientists to create a model for Predictive Scenarios without having to specify the training dataset source, as it can be automatically looked up from the PAI system.

In some implementations, the framework enables the tailoring of predictive models to target different partitions of data being analyzed. The appropriate predictive model to execute may be determined at runtime based on context specification through the calling application or otherwise.

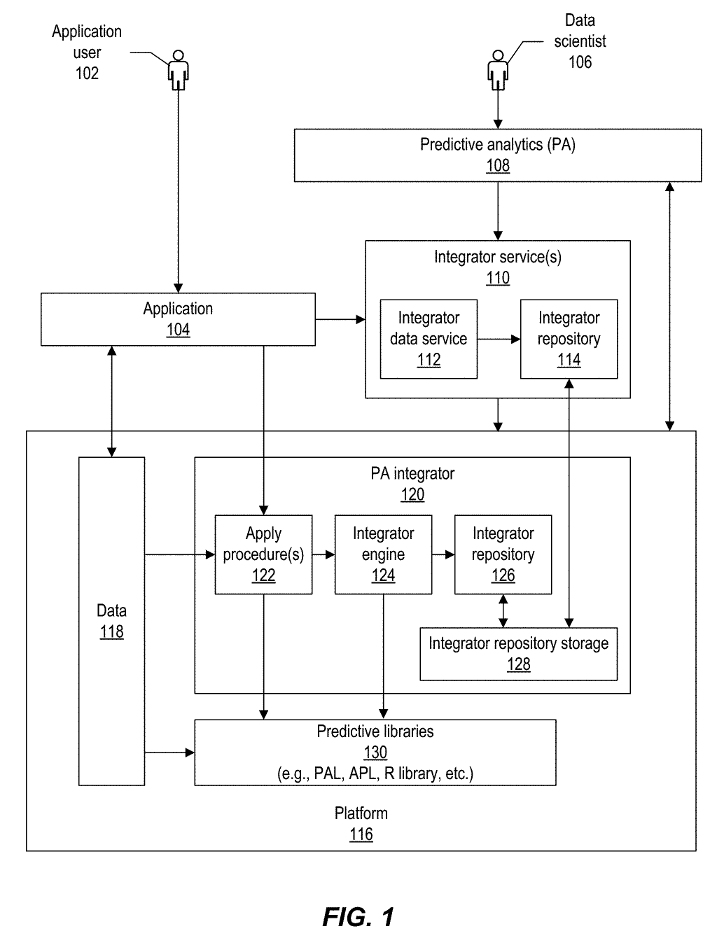

FIG. 1 depicts an example system (e.g., a high level architecture) for predictive model integration, according to implementations of the present disclosure. As shown in the example of FIG. 1, the system may include an application 104 that is associated with an application user 102. The application may be any appropriate type of application that may employ predictions made through the predictive model(s). The system may also include predictive analytics (PA) 108 that may be employed by a data scientist 106 or other user. The PA 108 may also be described as Business Objects PA. The PA 108 may call integrator service(s) 110 that include an integrator data service 112 which calls an integrator repository 114. The system may include a platform 116, such as a data platform. In some instances, the platform 116 may be a data processing and storage environment, which may operate as a database management system, database server, data storage, and/or data analytics platform. For example, the platform 116 may be an instance of SAP HANA™. The platform 116 may include data 118 (e.g., data storage) and a PA integrator 120. The PA integrator 120 may include apply procedure(s) 122 which are created by an integrator engine 124, which calls an integrator repository 126. In some implementations, the system may include the integrator repository 126 that is executing within the platform 116 and/or the integrator repository 114 that is executing outside the platform. The PA integrator 120 may include an integrator repository storage 128. The platform 116 may include predictive libraries 130, such as PAL, APL, R library, and so forth. The libraries 130 access the data 118, and may also interact with the apply procedure(s) 122 and/or the integrator engine 124. The integrator repository 126 and/or integrator repository 114 may interact with the integrator repository storage 128. The PA 108 and/or integrator service(s) 110 may interact with the platform 116. In some implementations, the application 104 may call the apply procedure(s) 122. The application 104 may also call the integrator service(s) 110 as an intermediary to interact with the platform 116. The application 104 may also have access to the data 118 stored within the platform 116.

The platform 116 may include any suitable number and type of computing devices that execute the various components of the platform 116, as shown in FIG. 1. The application 104, PA 108, and/or integrator service(s) 110 may execute on the same computing device(s) as the platform 116, or on different computing device(s) that communicate with the platform 116 over one or more networks.

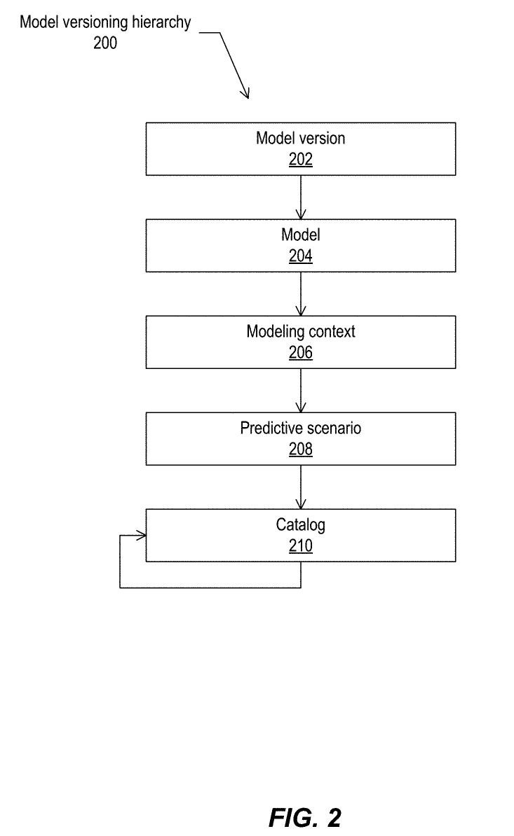

The libraries 130 may store objects at any level of the model versioning hierarchy, described below with reference to FIG. 2. For example, the model repository storage 128 may store model versions, models, modelling contexts, predictive scenarios, and/or one or more catalogs that include versions models, modelling contexts, and/or predictive scenarios. In some implementations, the libraries 130 are predictive libraries, e.g., stateless functions, which do not persist information. The functions of the libraries take some data, process it and return results. The libraries may be provided with all the requisite information to perform the requested processing, and successive calls to the library may not affect each other. The integrator engine may coordinate the various calls to the predictive models, and may also update the applied procedures when a new active model version is available. As described herein, the application may call the apply procedures as an API to request execution of data models, retraining of data models, and/or other operations regarding the objects stored in the repository.

In some implementations, the integrator repository storage ensures data persistence. Model versions, predictive scenarios, and so forth, may be stored in the integrator repository storage. The integrator repository is a component that exposes the repository information to the integrator services. The integrator repository includes logic to ensure all data provided to the repository and the engine is consistent. The processes inside the integrator repository may perform validations to ensure this consistency. The integrator repository also coordinates the integrator engine. The integrator engine is a component that is responsible to interact with the predictive libraries to train, retrain, and/or apply predictive models, and to generate the apply procedures for the Predictive Scenarios.

In some implementations, the predictive models may be stored in the storage 128. The storage 128 can be in the platform or on another system. For example, the models may be stored in another location remote from the libraries 130, e.g., external to the platform 116, and the libraries may be called from the integrator engine 124 to request that the models be executed from their storage location. The libraries may provide a framework, API(s), and/or other interface to enable predictive models to be called. In some implementations, the integrator engine is in the platform and executes independently of the integrator repository. For example, implementations may include a distributed system where the repository is found on a runtime environment (e.g., outside of the platform) and this environment is communicating with multiple instances of the platform layer. Within each instance of the platform, there may execute an instance of an integrator engine. The integrator repository coordinates each instance of the integrator engine. Predictive models present in the first instance of the platform could be copied into the second instance of the platform and may be executed on the engine available in the second instance. This scenario is applicable to cloud based systems.

Implementations allow for a loosely coupled integration of predictive model(s) with applications, allowing the integration components to be dropped in to the existing application stack without affecting the operability of the remaining components. Once integrated, applications may interface with the integrator services in order to manage the entities and functions made available by the integrator services. Applicants may interface with the (e.g., SQLScript) apply procedures or the integrator services to generate and retrieve predictions.

This indirect interfacing of applications with the predictive models allows for application administrators to change the underlying predictive models and libraries without any additional development and without otherwise affecting the operation of the main application. The integrator services may manage the updating of internal references to ensure the correct and error-free workflow when such a swap occurs between predictive models.

To ensure that the apply procedure(s) perform as fast as possible, the links to the predictive models may be hard-coded into the apply procedure(s) instead of requiring that the procedure dynamically look up the information from the integrator repository. Whenever the active model version changes for a predictive model, the integrator may update the apply procedure to ensure that the application uses the appropriate model to generate predictions. This update process manages the apply procedures which may include the generation and the update of the procedure definition.

The generation and maintenance of the apply procedures may be performed by the integrator engine, and this engine may be managed by the integrator service. The integrator service may interface with the engine to retrieve information from the predictive models using the functions provided by the predictive libraries. This information may then be processed into the common representation that applications(s) access through the service.

FIG. 2 depicts an example schematic of a model versioning hierarchy 200, according to implementations of the present disclosure. According to the hierarchy 200, a predictive model 204 may include any suitable number of model versions 202 of that model 204. A modeling context 206 may include any suitable number of models 204. A predictive scenario 206 may include any suitable number of modeling contexts 206. A catalog 210 may include any suitable number of predictive scenarios 208. A catalog 210 may also be associated with other catalogs 210 that each includes predictive scenario(s) 208, and so forth down the hierarchy.

A predictive scenario may represent a process (e.g., business process) or question that can be modelled using one or more predictive models. Within a predictive model repository, the predictive scenarios may be used to group predictive models that are related to each other under a common parent. Models within a predictive scenario may optionally be further segmented into modeling contexts. Using these modelling contexts, application administrators may define different partitions on the dataset and specify separate predictive models. The model management service also provides versioning capabilities for predictive models. Accordingly, within a predictive scenario, each model may have several model versions. Within the service, a particular predictive model created by a modelling tool such as the PA 108 may map to a particular model version.

A modelling context may be described as a collection or organization of models of a particular type or that may be used for a particular purpose. For example, a modelling context may be a collection of models that are usable within a particular organization or department within a larger organization. As a particular example, a modelling context may be associated with a finance or human resources (HR) department of a business, and the modelling context may include models that are particularly relevant to those departments. For example, a modelling context associated with an HR department may include models for predicting employee absences, payroll, probable hires, security issues, and so forth. In some instances, a modelling context may be associated with some other category, such as a geographical region.

Each predictive scenario object may represent a contract between a predictive model and an application, e.g., an agreement that the application is to call the model with a certain set of parameters and the model is to return results in a certain format. This contract may be expressed in terms of the signature of the predictive model that is accepted by the predictive scenario. This signature may describe the format of the input and output data structures and the parameters that the model accepts. In some implementations, applications may create predictive scenario objects through a service that exposes an API to manage the entities of the model repository. The API exposes information regarding the predictive scenarios and the predictive models in a common format that is agnostic with regard to the underlying technology.

Applications may interact with the predictive scenarios without any knowledge of the underlying model. When a predictive scenario is created, a corresponding API is generated that can be used by developers to integrate the predictive scenario into their application. The signature of this API may be described by the predictive scenario and may be immutable throughout the life of the predictive scenario. This immutability of the signature ensures that the information that is submitted and returned by the API remains the same structurally, thus ensuring that API calls will work in the future. Example Code 1, below, shows an example result of a GET request for a predictive scenario, the GET request submitted by an application.

### Example Code 1

```
GET “/umml/PredictiveScenarios(‘6c156b2d-da98-4f83-80a2-62574e590e37’)
{
  “@odata.id” : “/umml/PredictiveScenarios(‘6c156b2d-da98-4f83-80a2-62574e590e37’)”,
  “GUID” : “6c156b2d-da98-43-80a2-62574e590e37”,
  “name” : “FraudsterDetector”,
  “parent” : “/umml/Catalog(‘8358096b-039e-47d9-84d0-f30a0ddb4ba2’)”,
  “description” : “Find the persons who might lie regarding their age”,
  “scenarioType” : “Regression”,
...
“signature” : {
  “inputs” : [
  {
    “name” : “inputDataset”,
    “description” : “Structure of the expected input dataset ”,
    “structure” : [
      { “position” : 1, “name” : “id”, “storage” : “integer”, “type”: “key”},
      { “position” : 2, “name” : “age”, “storage” : “integer”},
      ...
      { “position” : 15, “name” : “native-country” , “storage” : “string”},
      { “position” : 16, “name” : “class”, “storage” : “integer”, “type” : “target” }
    ]
  }
  ],
  “outputs” : [
  {
      “name” : “applyOutDataset”,
      “description”: “Structure of the generated results”,
      “structure” : [
        { “position” : 1, “name” : “apply_id”, “storage” : “integer”, “type” : “apply-info” },
        { “position” : 2, “name” : “id”, “storage” : “integer”, “type” : “key” },
        { “position” : 3, “name” : “age”, “storage” : “integer”, “type” : “target” },
        { “position” : 4, “name” : “rr_age”, “storage” : “number”, “type” : “prediction” }
      ]
  }
  ]
}
“activeModelVersion” : “/umml/ModelVersions(‘27f91587-dbe3-4b1d-a4a7-9926247428b3’)”,
  “models” : [
    { “@odata.id” : “/umml/Models(‘f21511b7-d7a8-46ff-a6f1-85e94a433d8c’)” }
  ]
}
```

In some implementations, applications may generate predictions using at least two different approaches. In one approach, an application can initiate an apply task using a web API provided by the model management service. In another approach, an application can use an apply procedure (e.g., a SQLScript procedure) that is generated when the predictive scenario is created. When calling an apply procedure, an application may not need to specify which predictive model to run. Instead, the application may provide a context specification which is then used to determine which predictive model is to be called. The context specification provided by the application may be mapped to a modelling context. Example Code 2, below, lists various types of sample code for invoking an apply procedure.

### Example Code 2

-- Create a configuration table
create table IN_MC_CONFIGURATION like umml_engine_configuration_table_type;
-- Specify which modelling context to run against
insert into IN_MC_CONFIGURATION (“Key”, “Value”) values (‘ModellingContext’, ‘My
modelling context’);
-- Create a parameters table with which we can provide the apply time model parameters
create table IN_MODEL_PARAMETERS like umml_engine_apply_parameters_table_type
-- Specify a runtime parameter for the model
insert into IN_MODEL_PARAMETERS (“Key”, “Value”) values (‘Threshold’, ‘0.55’);
-- Create a table in which we can store the output of the apply
-- The expected structure of this table is available from the PredictiveScenario
create table OUT_PREDICTIONS(“id” INTEGER, “PredictedValue” INTEGER,
“UMML.ApplyId” nvarchar(32));
-- Create an empty error table in which we can receive errors
create table OUT_APPLY_ERRORS like umml_engine_apply_errors_table_type;
-- Call the apply procedures using some data
-- Store the predictions in the table called OUT_PREDICTIONS
call “MY_CLIENT_SCHEMA”.“UMML_PS_INLINE_APPLY_12”
(IN_MC_CONFIGURATION, IN_MODEL_PARAMETERS, MY_INPUT_DATA,
OUT_PREDICTIONS, OUT_APPLY_ERRORS) with overview;
-- Read the predictions
select * from OUT_PREDICTIONS;
-- Read the errors
select * from OUT_APPLY_ERRORS;

In some implementations, each modelling context specifies an active model version. When a model version of a predictive model, e.g., created by the PA, is exported to the model management service, users may have the ability to specify whether that model version should be the active model version for a specific modelling context. In some implementations, each predictive scenario has one active model version per modelling context. During the execution of the apply procedure, the active model version of the modelling context may be executed to generate predictions.

When the active model version changes for a predictive scenario (e.g., is hot-swapped), the corresponding apply procedure may be updated with the new information regarding which model version is active. This update may occur without a change to the apply procedure's signature. Accordingly, from the perspective of the application the procedure has not changed. This ensures that applications will not be broken, and will continue to execute without needing code changes, following a change in the underlying predictive model, given that the applications may interact solely with the apply procedure. For example, an application may make a first call to a model, the currently active model version may be executed by the system and the prediction result(s) generated by that model version may be returned to the application. The application may make a subsequent call to the model and, if the currently active model version has changed since the first call, the new active model version may be executed and the results of that execution may be returned to the application.

When invoking the apply procedure, applications may be able to provide additional configurations and model parameters that will be applied to the predictive model. These model parameters may include a set of key value pair properties that the designer of the predictive model may choose to expose to the users. These parameters can be used to alter the behavior of the model and thus alter the predicted values generated by the model.

Some implementations support an alternative approach of a service-oriented apply, in which applications invoke a service. This approach may employ a SQLScript procedure as an apply procedure. The results of the apply procedure may be stored in a table (e.g., a HANA table) that may be specified by either the service or the application. The generated predictions can be accessed from the table by the application at a later time. Moreover, the service based apply invocation allows for an asynchronous prediction generation. Additionally, the service based apply and/or retrain could also potentially be scheduled. Additionally, the service based apply could have functionalities to directly reference an active or non-active model version to generate predictions for any predictive model found under a Predictive Scenario.

Over time, the nature of the data that the predictive model operates on may change, and the model's performance may therefore degrade. To ensure continued accuracy of the model, the model may be periodically retrained based on new data. The integrator services may enable applications to requesting a retraining the predictive models that are registered in the integrator repository. Retraining may generate a new version of a model, and after retraining is complete a new version of the predictive model may be made available in the repository. In some instances, applications interfacing with the integrator services may be able to specify the dataset that is to be used to retrain the model(s). Example Code 3, below, lists an example POST request to retrain a model version, which may be submitting by an application.

### Example Code 3

```
POST /uml/ModelVersion(‘27f91587-dbe3-4b1d-a4a7-9926247428b3’)/
retrain
{
“bindings”: {
    “inputs”: [{
    {
    “name”: “inputData”,
    “reference”: “/umml/Dataset(‘27f45587-deb3-4b1d-a4a7-
    9921111428b3’)”
    }],
    “parameters”: [{
    {
    “name”: “numberOfClusters”,
    “value”: 8
    }]
}
}
```

In some implementations, using the PA users may define parameters for predictive models, including parameters that can be specified during the retraining of the model. The PA integrator may prompt the calling applications to provide values for these parameters during a request for retraining, and the retraining of the predictive model may be performed according to the provided parameter values.

In some implementations, the output of a particular model version of a model may be monitored over time, to determine whether the output has deviated in some manner that may indicate a degradation in the quality of the model version. Based on a determination that the quality of the output predictions has degraded beyond an acceptable threshold level, the model may be retrained automatically to generate a new model version. Alternatively, an application may send a request for model retraining as described elsewhere herein. In some implementations, a model may be retrained periodically (e.g., every month, every week, etc.) to ensure that the model is up-to-date and producing sufficient quality results.

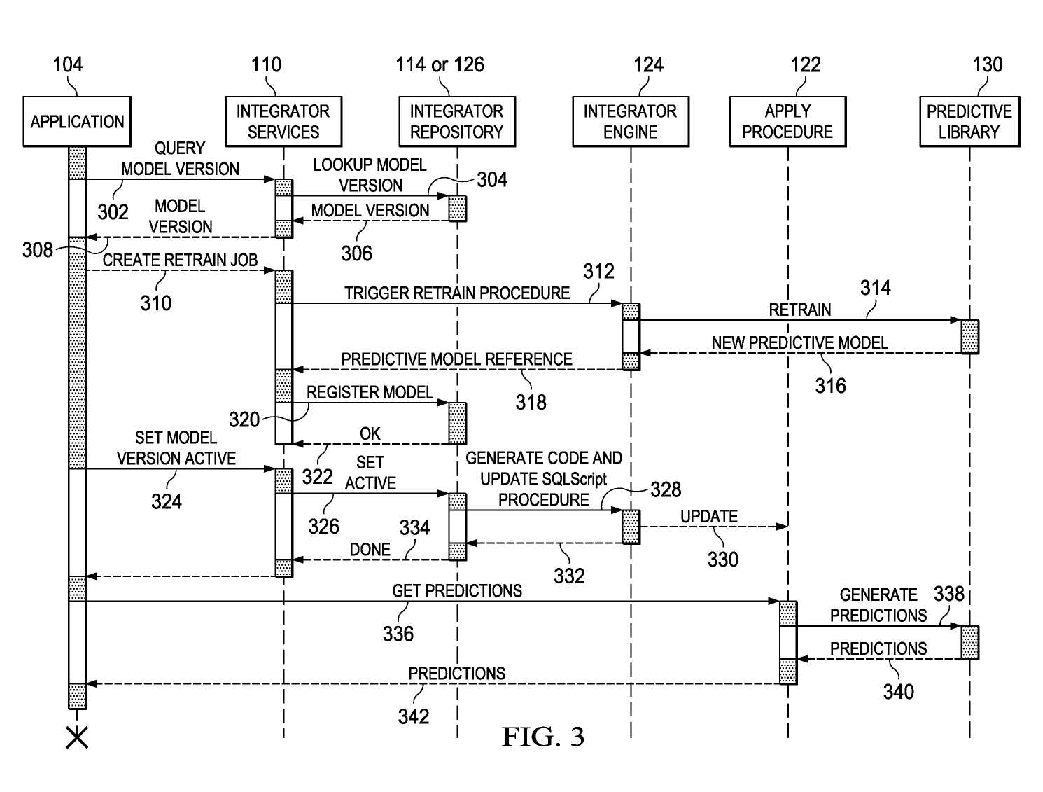

FIG. 3 depicts a flow diagram of example processes for predictive model integration, according to implementations of the present disclosure. Operations of the process may be performed by any of the software module(s) described with reference to FIG. 1, in the platform 116 or elsewhere. The flow diagram of FIG. 3 depicts four different example processes that may be performed to use and/or maintain predictive models: a query model version process, a create retrain job process, a set model version process, and a get predictions process.

In a first example process to query model version, the application may query (302) the integrator services to determine what is the current active model version for a particular model. The integrator services may respond to the query by sending a request (304) to the integrator repository to look up the current model version. The integrator repository may return (306) the model version to the integrator services, which may return (308) the model version to the application. Based on the returned model version, the application may determine whether the model is sufficiently updated or the model is to be retrained. If a determination is made that the model is out of date, the application may request a retrain job to executed to retrain the model.

In a second example process to create a retrain job, the application may send a request (310) to the integrator services to create a retrain job to retrain a particular model. The integrator services may respond to the request by sending a message (312) to the integrator engine to trigger a retrain procedure for the particular model. The integrator engine may send a message (314) to the predictive library in the libraries 130, indicating that the model is to be retrained. The library may respond (316) indicating that the model has been retrained and sending a reference to the retrained model. The integrator engine may forward (318) the predictive model reference to the integrator services, which may register (320) the model with the integrator repository based on the reference. The integrator repository may respond (322) indicating that the model was successfully registered.

In a third example process to set an active model version, the application may send a message (324) to the integrator services indicating that a particular model version is to be set to the active version for a particular model. The integrator services may send a message (326) to the integrator repository indicating that the specified version is to be set to the active version of the model. The integrator repository may respond to the message by instructing (328) the integrator engine to generate code and update (330) the apply procedure (e.g., SQLScript procedure) for the particular model. The integrator engine may respond (332) to indicate that the update is complete, and the response may be forwarded (334) back to the application through the integrator services.

In a fourth example process to get predictions, the application may call (336) an apply procedure to request that a predictive model be executed. The apply procedure may call (338) the appropriate predictive library to instruct the library to execute the model. The library may receive predictive results, i.e., predictions, from the model and return (340) the results to the apply procedure, which may return (342) the results to the calling application. In addition to returning the predictions to the user, in some implementations the predictions may be written to a table in the database in order to persist the results to be accessed later by the application.

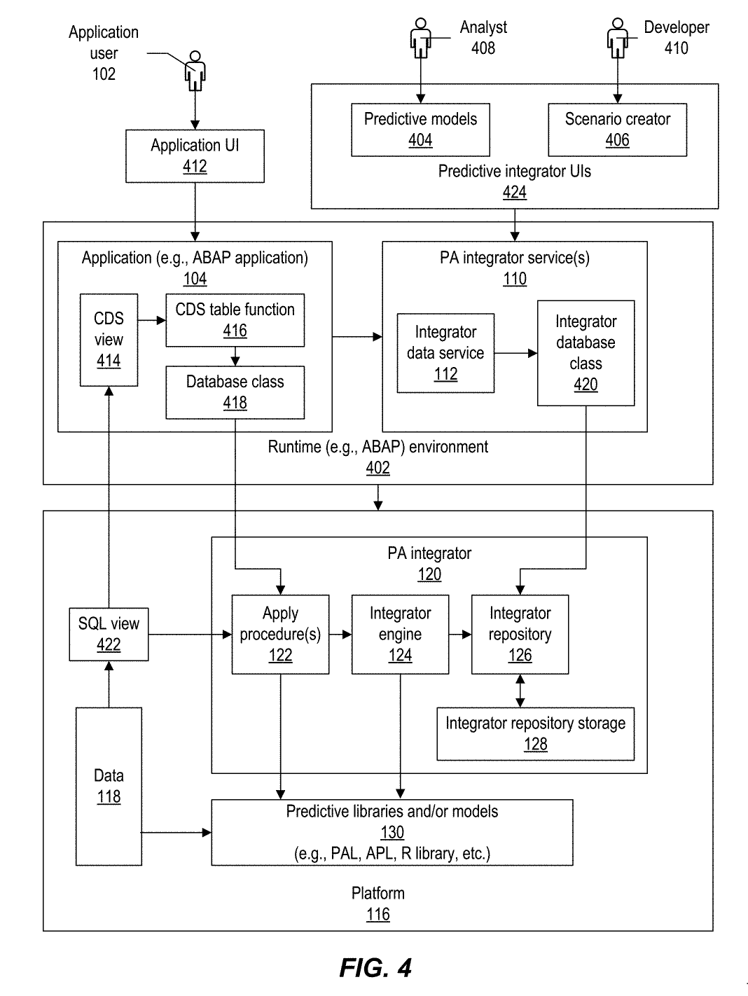

FIG. 4 depicts an example system for predictive model integration, according to implementations of the present disclosure. Elements of FIG. 4 may be similarly configured, and/or perform similar operations, to like-numbered elements of FIG. 1. As shown in FIG. 4, the system may include a middle layer that is a runtime environment 402, such as a runtime environment to execute applications written in the SAP ABAP™ language. In some implementations, the environment may be SAP NetWeaver™. In some implementations, the application 104 may include a CDS view 414 which calls CDS table function(s) 416, which call database class(es) 418. The PA integrator service(s) 110 may include an integrator database class 420 that is called from the integrator data service 112. The platform 116 may include a SQL view 422 that interfaces with the data 118 and the apply procedure(s) 122, and the SQL view 422 may be called from the CDS view 414 of the (e.g., ABAP) application 104. As shown in the example of FIG. 4, data may flow from the SQL view to the CDS view. These views may be read-only. The user 102 may interact with the application 104 through an application UI 412 that may execute outside the runtime environment 402. Moreover, the system may include predictive integrator UIs 424, including predictive models 404 and a scenario creator 406. Users such as an analyst 408 and a developer 410 may interact, respectively, with the predictive models 404 and the scenario creator 406 in the UIs 424.

In some instances, the application 104 executes with the runtime environment 402 to enforce security and ensure that only authorized users are able to access the prediction results generated by the predictive models. In this way, the consumption and the administration of the surfacing of the predictions may be described as an application-specific domain. Applications may be written to access the predictions, and the application may be responsible to restricting access to authorized users.

As shown in the example of FIG. 4, a PA integrator can be included in an ABAP runtime environment that executes ABAP-based applications. An ABAP version of the integrator services may be made available for applications that work with a particular version (e.g., a HANA version) of the integrator repository. Applications may interact with the services by connecting to the PA integrator services that are running within the same (e.g., ABAP) runtime environment. Because the PA integrator services execute in the same system, the integrator is able to access and work with the data stored in the platform (e.g., a HANA database).

The predictions generated by the apply procedure, for a predictive scenario, can be exposed seamlessly through the use of the CDS table function(s). Within an ABAP landscape, for example, information is may be accessed through the CDS framework using CDS views. CDS views define a view for the data stored in the database and allow ABAP applications to natively query this information while the framework abstracts away and manages the data conversion. CDS table functions may provide an alternative to CDS views. Although queried in the same fashion, the behaviors are different between CDS table functions and CDS views. For example, when a CDS view is created, information may be retrieved from one or more tables found in the database. When a CDS table functions is created, instead of defining the tables from where information is accessed, application developers can write code in the form of ABAP managed database procedures (AMDP) that return information in the format of the table function's signature. This feature allows ABAP developers to execute HANA SQLScript procedures within CDS table functions and return the result of the procedures as if the application was querying a standard view.

When ABAP application developers wish to embed a predictive scenario into their applications, they may create a CDS table function that corresponds to the output signature of the predictive scenario, and have the application call the corresponding apply procedure to return the prediction results using the CDS table function. Example Code 4, below, lists an example CDS view as a CDS table function, showing an example for the SFLIGHT data set.

### Example Code 4

```
@ClientDependent:false
@EndUserText.label: ‘Prediction of Seat Occupation’
@VDM:{viewType: #BASIC, private:false}
@Analytics:{dataCategory: #FACT , dataExtraction.enabled:true }
define table function I_FlightPrediction
  with parameters
      @EndUserText.label: ‘Airline Code’
      p_Carrid : abap.char(3),
      @EndUserText.label: ‘Start Year’
      p_StartYear : abap.char(4),
      @Consumption.hidden
      p_ModellingContext : TEXT100
  returns {
      @EndUserText.label : ‘Airline Code’
      key Carrid : abap.char(3);
      @EndUserText.label : ‘Period’
      key Period : abap.char(7);
      @EndUserText.labl : ‘Occupied Seats’
      SeatsOcc : abap.int2;
}
implemented by method TF_FlightSeats_CLASS=>
predictSeatOccupation;
```

Example Code 5, below, provides an example AMDP implementation of the CDS table function shown in Example Code 4.

### Example Code 5

```
public section.
interfaces IF_AMDP_MARKER_HDB.
      class-methods predictSeatOccupation
            for table function I_FlightPrediction.
protected section.
private section.
endclass.
class TF_FlightSeats_CLASS implementation.
      method predictSeatOccupation
      by database function for hdb
      language sqlscript options read-only.
            call
“SAP_UMML_ENGINE_DYNAMIC”.-
”SFLIGHT_PredictiveScenarioApply”
(p_ModellingContext, predictionResult);
            return
                  select Carrid, Period, “prediction” AS SeatsOcc
                  from :predictionResult;
      endmethod.
endclass.
```

As a particular example, a set of Fiori applications may be available within a S4HANA landscape that reduces the effort required to enable an application to use the PA integrator. There are at least two different approaches that an application may employ in using PA integrator. Applications may employ a closely coupled approach in which application users are not aware of the PA integrator. In such examples, the PA integrator repository operations are triggered by the main application that is unknown to a user. Applications may also employ a loosely coupled approach in which application users are aware of PA integrator. In such examples, the application developers may have created predictive scenarios for different types of users, and it may be left to the application users to create modelling contexts that include model versions for these processes.

A set of configuration Fiori applications may interact with the PA integrator services, allowing users to configure and maintain the objects in the integrator repository. If an application development team chooses to embed a PA integrator in a loosely coupled fashion, the predictive models application can be used by users to create modelling contexts and model versions. Additionally, the application allows users to retrain certain model versions within the application without the need to use Predictive Analytics. For application developers, a scenario creator Fiori application may be provided to enable developers to inspect and create predictive scenarios in the system. Such a scenario creator may enable developers to add predictive functionality within their applications.

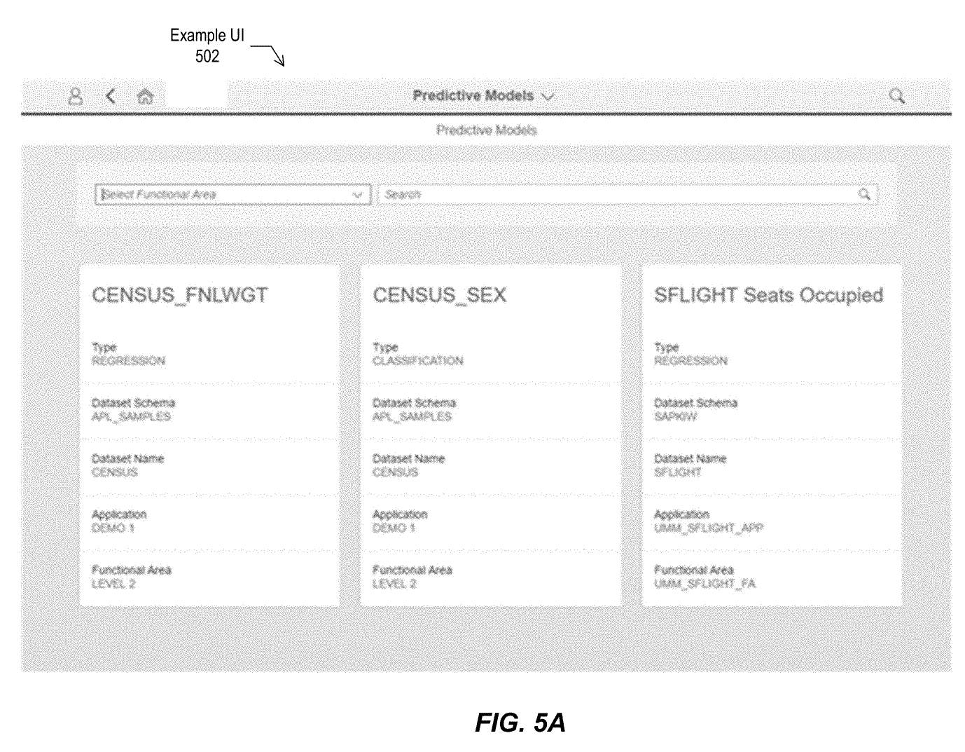

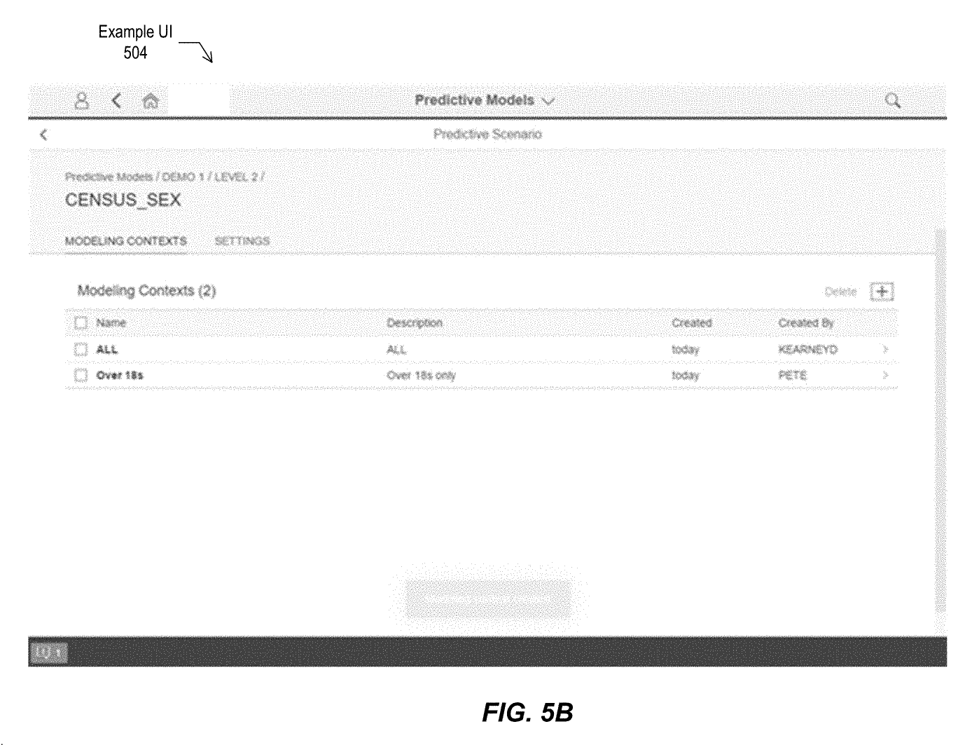

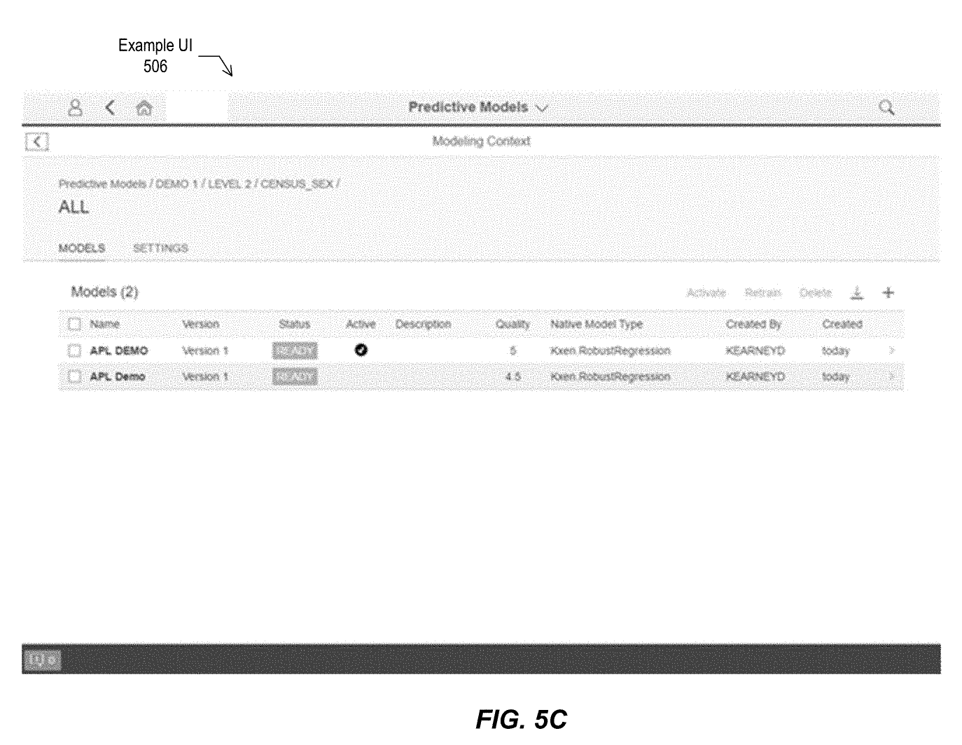

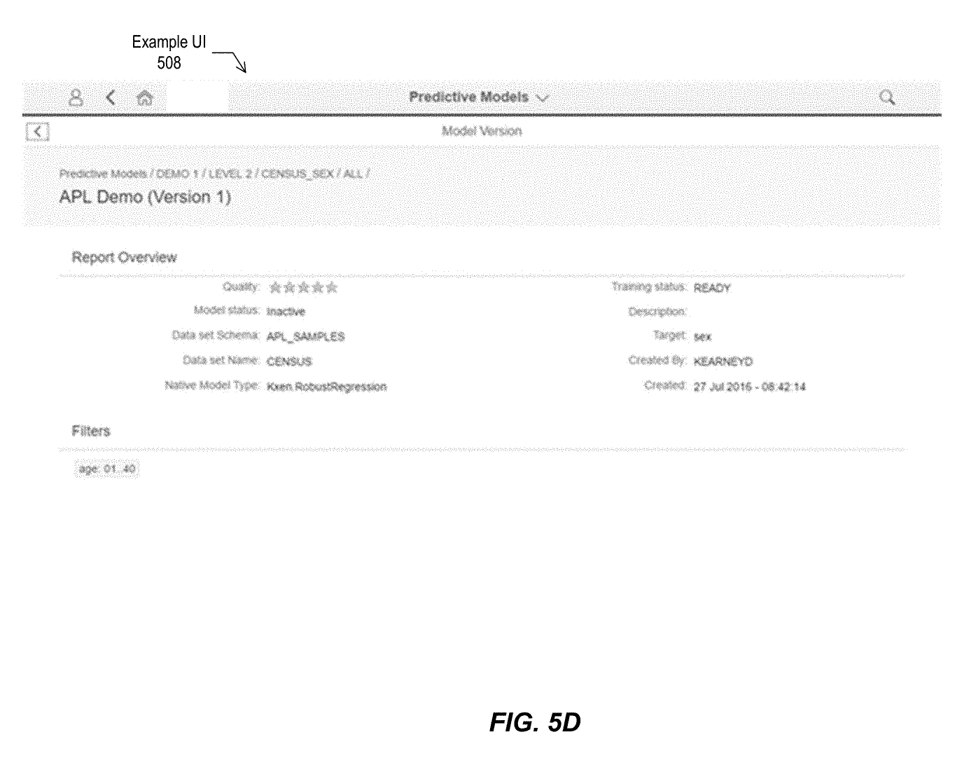

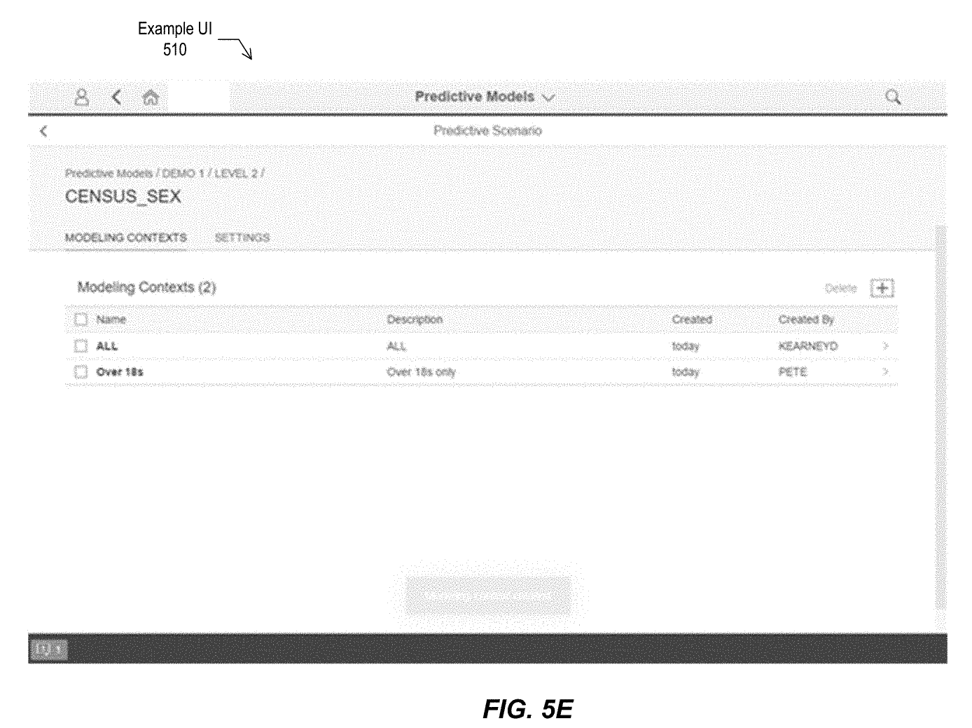

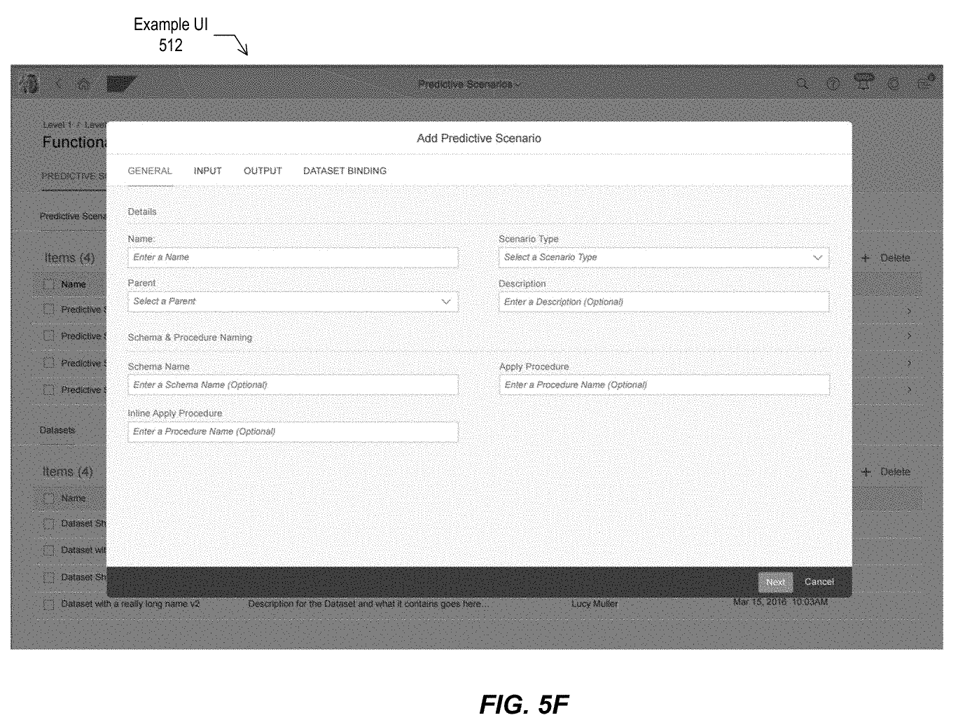

FIGS. 5A-5F depict example user interfaces (UIs) for a scenario creator, according to implementations of the present disclosure. FIG. 5A depicts an example UI 502 for browsing predictive scenarios. FIG. 5B depicts an example UI 504 for browsing modeling contexts within a particular predictive scenario selected by a user. FIG. 5C depicts an example UI 506 for browsing modeling versions within a particular modelling context selected by a user. FIG. 5D depicts an example UI 508 for viewing a model version report for a selected model version. FIG. 5E depicts an example UI 510 for selecting a modeling context. FIG. 5F depicts an example UI 512 for adding a predictive scenario.

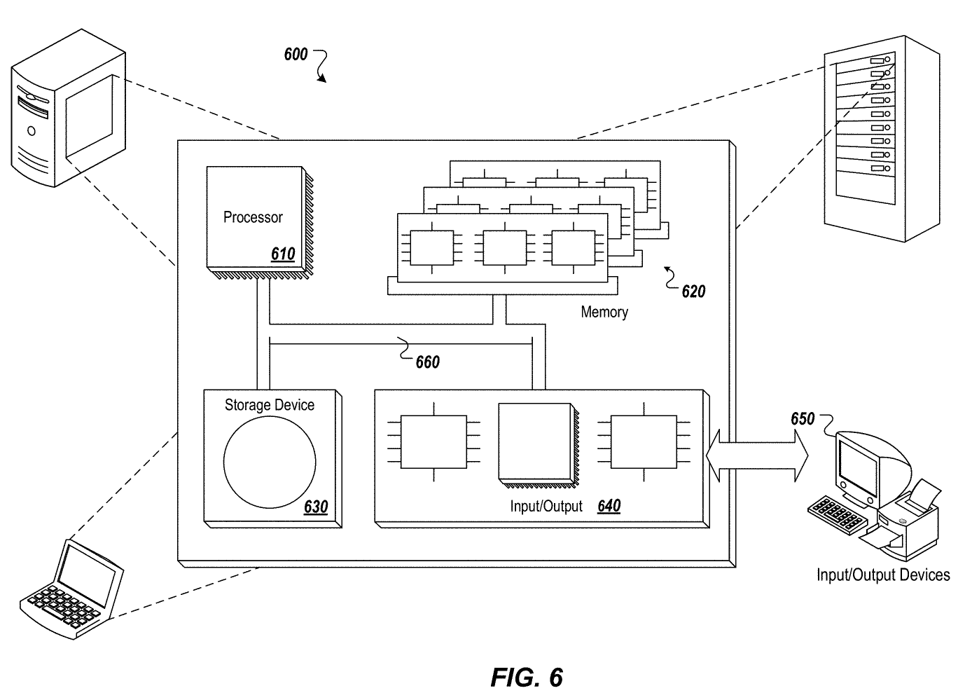

FIG. 6 depicts an example computing system, according to implementations of the present disclosure. The system 600 may be used for any of the operations described with respect to the various implementations discussed herein. For example, the system 600 may be included, at least in part, in the platform 116 and/or other computing device(s) or system(s) described herein. The system 600 may include one or more processors 610, a memory 620, one or more storage devices 630, and one or more input/output (I/O) devices 650 controllable via one or more I/O interfaces 640. The various components 610, 620, 630, 640, or 650 may be interconnected via at least one system bus 660, which may enable the transfer of data between the various modules and components of the system 600.

The processor(s) 610 may be configured to process instructions for execution within the system 600. The processor(s) 610 may include single-threaded processor(s), multi-threaded processor(s), or both. The processor(s) 610 may be configured to process instructions stored in the memory 620 or on the storage device(s) 630. For example, the processor(s) 610 may execute instructions for the various software module(s) described herein. The processor(s) 610 may include hardware-based processor(s) each including one or more cores. The processor(s) 610 may include general purpose processor(s), special purpose processor(s), or both.

The memory 620 may store information within the system 600. In some implementations, the memory 620 includes one or more computer-readable media. The memory 620 may include any number of volatile memory units, any number of non-volatile memory units, or both volatile and non-volatile memory units. The memory 620 may include read-only memory, random access memory, or both. In some examples, the memory 620 may be employed as active or physical memory by one or more executing software modules.

The storage device(s) 630 may be configured to provide (e.g., persistent) mass storage for the system 600. In some implementations, the storage device(s) 630 may include one or more computer-readable media. For example, the storage device(s) 630 may include a floppy disk device, a hard disk device, an optical disk device, or a tape device. The storage device(s) 630 may include read-only memory, random access memory, or both. The storage device(s) 630 may include one or more of an internal hard drive, an external hard drive, or a removable drive.

One or both of the memory 620 or the storage device(s) 630 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 600. In some implementations, the CRSM may include a data store that provides storage of computer-readable instructions or other information in a non-transitory format. The CRSM may be incorporated into the system 600 or may be external with respect to the system 600. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 610 and the memory 620 may be supplemented by, or incorporated into, one or more application-specific integrated circuits (ASICs).

The system 600 may include one or more I/O devices 650. The I/O device(s) 650 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 650 may also include one or more output devices such as a display, LED(s), an audio output device (e.g., a speaker), a printer, a haptic output device, and so forth. The I/O device(s) 650 may be physically incorporated in one or more computing devices of the system 600, or may be external with respect to one or more computing devices of the system 600.

The system 600 may include one or more I/O interfaces 640 to enable components or modules of the system 600 to control, interface with, or otherwise communicate with the I/O device(s) 650. The I/O interface(s) 640 may enable information to be transferred in or out of the system 600, or between components of the system 600, through serial communication, parallel communication, or other types of communication. For example, the I/O interface(s) 640 may comply with a version of the RS-232 standard for serial ports, or with a version of the IEEE 1284 standard for parallel ports. As another example, the I/O interface(s) 640 may be configured to provide a connection over Universal Serial Bus (USB) or Ethernet. In some examples, the I/O interface(s) 640 may be configured to provide a serial connection that is compliant with a version of the IEEE 1394 standard.

The I/O interface(s) 640 may also include one or more network interfaces that enable communications between computing devices in the system 600, or between the system 600 and other network-connected computing systems. The network interface(s) may include one or more network interface controllers (NICs) or other types of transceiver devices configured to send and receive communications over one or more communication networks using any network protocol.

Computing devices of the system 600 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 600 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A computer-implemented method performed by at least one processor, the method comprising:
providing, by the at least one processor, a plurality of apply procedures that are each associated with a predictive model for generating predictions based on input data;
receiving, by the at least one processor, a first call from an application to an apply procedure and, in response, requesting that a predictive library execute a first version of the predictive model associated with the apply procedure; and
providing, by the at least one processor, to the application, the predictions generated through execution of the first version of the predictive model.

2. The method of claim 1, further comprising:
receiving, by the at least one processor, from the application, a request to retrain the predictive model and, in response, sending an instruction to the predictive library to cause the predictive model to be retrained; and
receiving, by the at least one processor, an indication that the predictive model has been retrained to provide a second version of the predictive model.

3. The method of claim 2, further comprising:
receiving, by the at least one processor, a second call from the application to the apply procedure and, in response, requesting that the predictive library execute the second version of the predictive model associated with the apply procedure; and
providing, by the at least one processor, to the application, the predictions generated through execution of the second version of the predictive model.

4. The method of claim 3, wherein the first call and the second call from the application include the same set of input parameters.

5. The method of claim 1, wherein the plurality of apply procedures include one or more SQLScripts.

6. The method of claim 1, further comprising:
in response to receiving the first call from the application to the apply procedure, determining, by the at least one processor, that the first version of the predictive model is the active version to be executed.

7. The method of claim 1, wherein the predictive library is at least one of a Predictive Analytics Library (PAL), an Automated Predictive Library (APL), or a R library.

8. The method of claim 1, wherein:
the first call includes one or more parameter values provided by the application; and
the predictive model is executed based on the one or more parameter values.

9. A system comprising:
at least one processor; and
a memory communicatively coupled to the at least one processor, the memory storing instructions which, when executed, cause the at least one processor to perform operations comprising:
providing a plurality of apply procedures that are each associated with a predictive model for generating predictions based on input data;
receiving a first call from an application to an apply procedure and, in response, requesting that a predictive library execute a first version of the predictive model associated with the apply procedure; and
providing, to the application, the predictions generated through execution of the first version of the predictive model.

10. The system of claim 9, the operations further comprising:
receiving, from the application, a request to retrain the predictive model and, in response, sending an instruction to the predictive library to cause the predictive model to be retrained; and
receiving an indication that the predictive model has been retrained to provide a second version of the predictive model.

11. The system of claim 10, the operations further comprising:
receiving a second call from the application to the apply procedure and, in response, requesting that the predictive library execute the second version of the predictive model associated with the apply procedure; and
providing, to the application, the predictions generated through execution of the second version of the predictive model.

12. The system of claim 11, wherein the first call and the second call from the application include the same set of input parameters.

13. The system of claim 9, wherein the plurality of apply procedures include one or more SQLScripts.

14. The system of claim 9, the operations further comprising:
in response to receiving the first call from the application to the apply procedure, determining that the first version of the predictive model is the active version to be executed.

15. The system of claim 9, wherein the predictive library is at least one of a Predictive Analytics Library (PAL), an Automated Predictive Library (APL), or a R library.

16. The system of claim 9, wherein:
the first call includes one or more parameter values provided by the application; and
the predictive model is executed based on the one or more parameter values.

17. One or more computer-readable storage media storing instructions which, when executed, cause at least one processor to perform operations comprising:
providing a plurality of apply procedures that are each associated with a predictive model for generating predictions based on input data;
receiving a first call from an application to an apply procedure and, in response, requesting that a predictive library execute a first version of the predictive model associated with the apply procedure; and
providing, to the application, the predictions generated through execution of the first version of the predictive model.

18. The one or more computer-readable storage media of claim 17, the operations further comprising:
receiving, from the application, a request to retrain the predictive model and, in response, sending an instruction to the predictive library to cause the predictive model to be retrained; and
receiving an indication that the predictive model has been retrained to provide a second version of the predictive model.

19. The one or more computer-readable storage media of claim 18, the operations further comprising:
receiving a second call from the application to the apply procedure and, in response, requesting that the predictive library execute the second version of the predictive model associated with the apply procedure; and
providing, to the application, the predictions generated through execution of the second version of the predictive model.

20. The one or more computer-readable storage media of claim 19, wherein the first call and the second call from the application include the same set of input parameters.
